(19) United States
(12) Patent Application Publication
(10) Pub. No.: US 2001/0026651 A1
(43) Pub. Date: Oct. 4, 2001

(54) Rolling element spacer in rolling guide device

(75) Inventors: Hidekazu Michioka, Tokyo (JP); Kentarou Nishimura, Tokyo (JP); Yasuyuki Abe, Tokyo (JP); Kiyomi Tamura, Tokyo (JP); Hiroshi Niwa, Tokyo (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: THK CO., LTD

(21) Appl. No.: 09/803,145

(22) Filed: Mar. 12, 2001

(30) Foreign Application Priority Data
Mar. 31, 2000 (JP) 97027/2000

(51) Int. Cl. F16C 19/00

(52) U.S. Cl. 384/51

(57) ABSTRACT

There is provided a rolling element spacer used in a rolling guide device having an endless circulation passage for balls, arranged alternately with many balls in the endless circulation passage, and circulating together with the balls in the endless circulation passage. In order to prevent the rolling element spacer from falling sideways and avoid a trouble such as malfunction of the rolling guide device, the rolling element spacer is formed such that its diagonal dimension in a thickness direction becomes larger than an inner diameter of the endless circulation passage.

### BACKGROUND OF THE INVENTION

1. Field of the Invention

The present invention relates to a rolling element spacer which, in various rolling guide devices each having an endless circulation passage for balls such as a linear guide device and a ball screw device, is interposed between the mutually adjoining balls in the endless circulation passage and reduces frictions between the balls and a heat generation to thereby smoothen the rolling thereof.

2. Description of the Related Art

Hitherto, as a rolling guide device in which a pair of members continuously performing a relative motion through an endlessly circulating ball row, there have been known devices such as a linear guide device which is used in a linear guide portion in a machine tool, a carrying device and the like and which guides a movable body such as a table on a stationary portion such as a bed or a saddle, and a ball screw which is used together with this linear guide device and which gives a stroke of a linear motion corresponding to a rotation amount of a motor to the movable body.

The former linear guide device comprises a bearing rail which is disposed on the stationary portion and in which a rolling groove for the balls is formed along a longitudinal direction, and a sliding base which has a load rolling groove facing the rolling groove of the bearing rail through many balls and in which there is formed an endless circulation groove for the balls rolling on the load rolling groove, and it is constituted such that, in accompaniment with the endless circulation of the balls, the sliding base supporting the movable body continuously performs the linear motion along the bearing rail. Further, reversely to this, there is a case where it is constituted such that the bearing rail is moved relative to the fixed sliding base.

On the other hand, the latter ball screw comprises a screw shaft in which there is formed a spiral ball rolling groove with a predetermined lead, and a nut member which has a load rolling groove facing the ball rolling groove through many balls and in which there is formed an endless circulation passage for the balls rolling on the load rolling groove, and it is constituted such that, in accompaniment with a relative rotation motion between the screw shaft and the nut member, the balls circulate in the endless circulation passage, and the nut member and the screw shaft relatively move in an axial direction.

On the other hand, in such a rolling guide device, since the individual ball circulating in the endless circulation passage mutually contacts with the balls positioned before and after it, in case that it is used at a high speed, there have been such fears that, besides the fact that the balls are worn in relatively short time by a friction between the balls for instance, there arises a disadvantage such as the fact that the ball or the load rolling groove generates a seizure owing to a friction heat. Therefore, as one for solving such a drawback, in Japanese Patent Laid-Open No. 315835/1999 Gazette, there is disclosed a rolling guide device in which a rolling element spacer is interposed between the balls mutually adjoining in the endless circulation passage.

In the rolling guide device disclosed in the above Gazette, it is adapted such that a synthetic resin made rolling element spacer referred to as separator is arranged alternately with the ball in the endless circulation passage, thereby preventing the balls from mutually contacting. Such a separator is formed in a disk-like form whose outer diameter is smaller than a diameter of the ball and, in its both front/rear faces contacting with the balls, there are formed spherical face seats whose curvatures are larger than a curvature of a spherical face of the ball. By this, as shown in FIG. 12, if the ball 100 and the separator 101 are alternately arranged without a gap in the endless circulation passage 102, each separator 101 becomes a state of being sandwiched between a pair of balls 100, 100 adjoining its both front/rear faces, so that it circulates in the endless circulation passage 102 together with the ball 100 while being held in its predetermined attitude.

However, it is difficult to arrange the balls 100 and the spacers 101 without a gap in the endless circulation passage 102 provided in the rolling guide device. Further, if an accumulated use time of such a rolling guide device is increased, a gap is generated between the ball 100 and the rolling element spacer 101 by a wear. In case that the gap between the rolling element spacer 101 and the ball 100 cannot be removed in this manner and the gap is generated resultantly, the attitude of the rolling element spacer 101 becomes unstable as shown in FIG. 13, so that there is a fear that it falls sideways between the balls 100 in the endless circulation passage 102.

And, in case that the rolling element spacer has fallen sideways in this manner, since a movement of the rolling element spacer is not restrained by the adjacent balls, the rolling element spacer is separated from the balls to spring out of the endless circulation passage and, in case of the ball screw device for instance, it is discharged outside from between a screw shaft and a nut member. Further, if one of the rolling element spacers drops out in this manner, the gap between the ball and the remaining rolling element spacer in the endless circulation passage widens increasingly, so that the rolling element spacer drops out one after another from the endless circulation passage.

On the other hand, if the rolling element spacer falls sideways in the endless circulation passage, since the ball attempts to run on this rolling element spacer, the balls are clogged without circulating in the endless circulation passage and, in the ball screw device for instance, there is a fear that the nut member is locked to the screw shaft, so that an operation becomes impossible.

### SUMMART OF THE INVENTION

The invention has been made in view of such a problem, and its object is to prevent the rolling element spacers arranged together with the balls in the endless circulation passage from falling sideways in the endless circulation passage, thereby providing a rolling element spacer capable of avoiding such a trouble that the rolling element spacer drops out of the endless circulation passage and the rolling guide device becomes impossible to operate.

In order to achieve the above object, the invention provides a rolling element spacer used in a rolling guide device in which a pair of members perform a relative continuous motion through an endlessly circulating ball row, interposed between balls mutually adjoining in its endless circulation passage, and circulating together with the balls, characterized in that a diagonal dimension in a thickness direction is larger than an inner diameter of the endless circulation passage.

According to such a technical means, since the rolling element spacer arranged in the endless circulation passage is formed such that the diagonal dimension in the thickness direction, i.e., a diagonal dimension between both front/rear faces contacting with a pair of balls, is larger than an inner diameter of the endless circulation passage provided in the rolling guide device, even if a gap is generated between the ball and the rolling element spacer and thus the rolling element spacer slants in the endless circulation passage, the rolling element spacer does not fall sideways completely because its corner portions engage with an inner wall of the endless circulation passage, so that it is restored to an original attitude, i.e., a stable state in which it is sandwiched by the balls from both sides while it circulates together with the balls. By this, it is possible to avoid such troubles that the rolling element spacer drops out of the endless circulation passage and that the balls are clogged in the endless circulation passage.

According to the rolling element spacer of the invention, by setting the diagonal dimension in the thickness direction of the rolling element spacer larger than the inner diameter of the endless circulation passage provided in the rolling guide device, even if the rolling element spacer slants in the endless circulation passage, such a drawback that this rolling element spacer falls sideways between the balls can be prevented, so that it becomes possible to avoid such a trouble that the rolling guide device itself becomes impossible to operate owing to the fact that the rolling element spacer, which has fallen sideways and thus is not held in a predetermined attitude by the balls, drops out of the endless circulation passage and thus the balls are clogged in the endless circulation passage.

### BRIEF DESCRIPTION OF THE DRAWINGS

FIG. 1 is a side sectional view showing one embodiment of a ball screw device in which rolling element spacers of the invention are arranged together with balls in an endless circulation passage;

FIG. 2 is a front sectional view of the ball screw device shown in FIG. 1;

FIG. 3 is a perspective view showing an arrangement state between the ball and the rolling element spacer in the endless circulation passage;

FIG. 4 is a view clearly showing various dimensions defined in the invention;

FIG. 5 is a sectional view showing a state that the rolling element spacer of the invention is slanted in the endless circulation passage;

FIG. 6 is an explanatory view showing a dimensional relation for, in case that an outer periphery face of the rolling element spacer of the invention is formed in a cylindrical form, computing its maximum outer diameter φd;

FIG. 7 is a view showing a right-angled triangle derived from the dimensional relation of FIG. 6;

FIG. 8 is a sectional view showing an example in which the outer periphery face of the rolling element spacer of the invention is formed in a concave face form;

FIG. 9 is a sectional view showing a contact state between the rolling element spacer whose outer periphery face is formed in the concave face form and an inner wall of the endless circulation passage;

FIG. 10 is an explanatory view showing a dimensional relation for, in case that the outer periphery face of the rolling element spacer of the invention is formed in the cylindrical form, computing a correction value Δd of its maximum outer diameter φd;

FIG. 11 is a view showing a right-angled triangle derived from the dimensional relation of FIG. 10;

FIG. 12 is a sectional view showing a state that conventional rolling element spacers and balls are arranged without gaps in the endless circulation passage; and

FIG. 13 is a view showing a problem in case that the gap is generated between the rolling element spacer and the ball, which are arranged in the endless circulation passage.

### DESCRIPTION OF THE PREFERRED EMBODIMENT

Hereunder, a rolling element spacer of the invention is detailedly explained on the basis of the attached drawings.

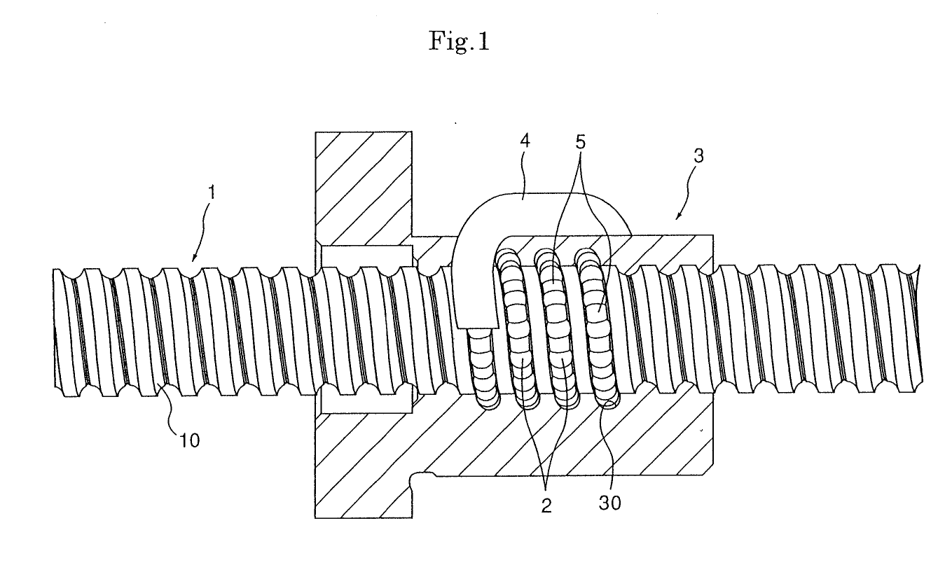

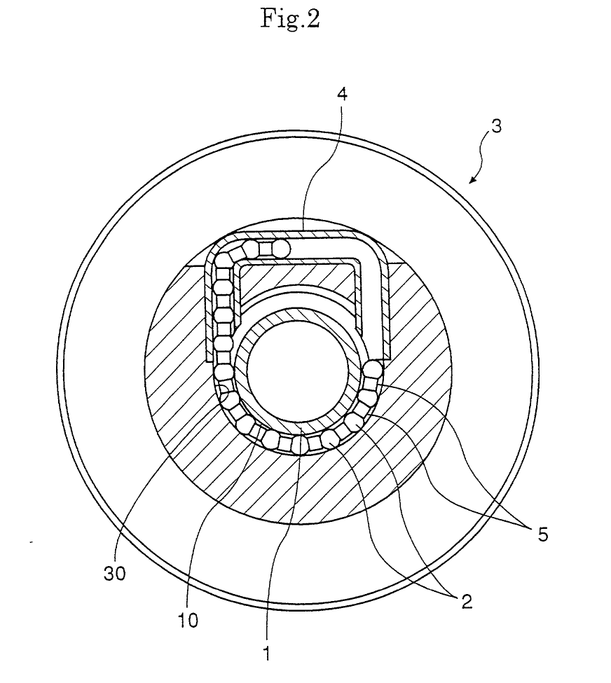

FIG. 1 and FIG. 2 show one embodiment of a ball screw device in which the rolling element spacers of the invention are arranged together with balls in an endless circulation passage. In these drawings, the reference numeral 1 denotes a screw shaft, the reference numeral 2 a ball and the reference numeral 3 a nut member, and the nut member 3 meshes with the screw shaft 1 through many balls 2.

A spiral ball rolling groove 10 is formed in an outer periphery face of the screw shaft 1, while a spiral load rolling groove 30 facing the ball rolling groove 10 of the screw shaft 1 is formed in an inner periphery face of the nut member 3, and the ball rolling groove 10 and the load rolling groove 30 form a spiral load ball passage between the screw shaft 1 and the nut member 3. That is, if a relative rotary motion occurs between the screw shaft 1 and the nut member 3, the ball 2 spirally rolls in the load ball passage while bearing a load. Further, a return pipe 4 mutually communicating both ends of the load ball passage to thereby constitute the endless circulation passage for the balls 2 is attached to the nut member 3, so that the ball 2 having finished to roll in the load ball passage and having been released from the load becomes a no-load state and rolls in the return pipe 4, and is returned to an inlet of the load ball passage while jumping the ball rolling groove 10 by several turns. Accordingly, if the screw shaft 1 and the nut member 3 are relatively rotated, it follows that the ball 2 rolls from the load ball passage to the return pipe 4 and from the return pipe 4 to the load ball passage, and is circulated inside the endless circulation passage constituted by the load ball passage and the return pipe 4.

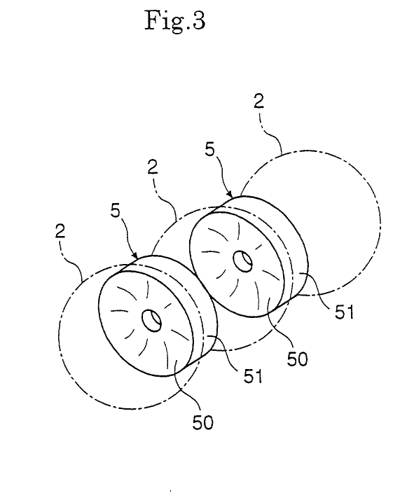

In this ball screw device, in order to prevent the balls 2 incorporated in the endless circulation passage from mutually contacting, a rolling element spacer 5 is interposed between the mutually adjoining balls 2, 2. As shown in FIG. 3, the rolling element spacer 5 is formed by deforming a synthetic resin into an approximately disk form and, in its both front/rear faces, there are respectively formed spherical faces 50 on which the balls 2 slide. The ball 2 and the rolling element spacer 5 are alternately arranged in the endless circulation passage. By this, it is adapted such that the balls 2 rolling in the endless circulation passage are prevented from mutually contacting, a smooth circulation of the ball 2 and, in turn, smoothening of the rotary motion of the nut member 3 relative to the screw shaft 1 are intended, and additionally a generation of noise owing to a collision between the balls during an operation of the ball screw device is reduced.

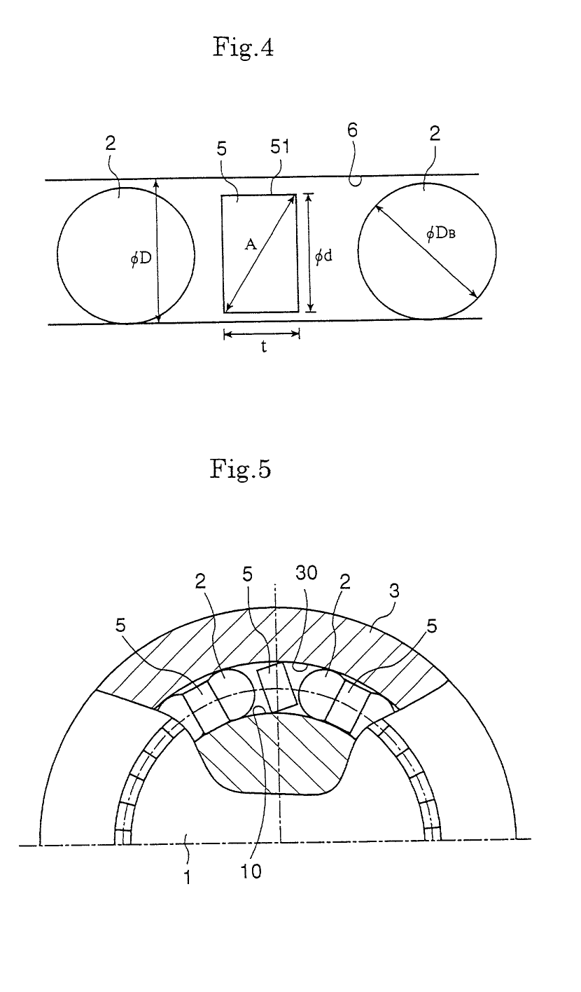

As shown in FIG. 4, such a rolling element spacer 5 is formed such that—when it is suppose that t is a thickness between both front/rear faces in which the spherical face seats 50 are formed and φd an outer diameter—a diagonal dimension A, in a thickness direction, expressed by √(d²+t²) becomes larger than an inner diameter φD of the endless circulation passage 6 for the ball 2. That is, the thickness t and the outer diameter φd of the rolling element spacer are set such that φD<A=√(d²+t²) is met. Therefore, it is adapted such that even in case that the gap is generated between the ball 2 and the rolling element spacer 5 in the endless circulation passage 6 and thus the rolling element spacer 5 slants without being supported in a predetermined attitude by the balls 2, since periphery edges of the rolling element spacer 5 formed in the disk-like form are locked by inner walls of the endless circulation passage as shown in FIG. 5, such a trouble is prevented that the rolling element spacer 5 falls sideways in the endless circulation passage 6.

Here, since the diagonal dimension A of the rolling element spacer 5 is determined by the thickness t and the outer diameter φd of the rolling element spacer 5, it follows that, in order to make the diagonal dimension A larger than the outer diameter φD, the thickness t or the outer diameter φd may be set large. However, in case that the thickness of the rolling element spacer 5 is set large, it follows that the number of the balls 2 in the endless circulation passage 6 is reduced correspondingly. Accordingly, in order to avoid a reduction in rated load of the ball screw device and avoid the device concerned from becoming large, it is preferable to set the thickness t small within such a range that the mutually adjoining balls 2 do not contact.

On the other hand, it is necessary that the outer diameter φd of the rolling element spacer 5 is smaller than a ball diameter φD_{B} and, even if the outer diameter φd is how large in this range, basically there is no problem. However, as shown in FIG. 2, in the ball screw, since the ball 2 and the rolling element spacer 5 spirally circulate around the screw shaft 1, in case that the outer diameter φd of the rolling element spacer 5 is too large, there is a drawback that the outer periphery face 51 of such rolling element spacer 5 interferes with the ball rolling groove 10 of the screw shaft 1. Further, also in another rolling guide device other than the ball screw, a linear guide device for instance, since a curved portion necessarily exists in the endless circulation passage, in case that the outer diameter φd of the rolling element spacer 5 is too large, there is also a drawback that the outer periphery face 51 of such rolling element spacer 5 interferes with an inner diameter side's wall of the endless circulation passage. Accordingly, in order to avoid such an interference between the rolling element spacer 5 and the inner wall of the endless circulation passage to thereby achieve a smooth ball circulation, it is necessary to limit a maximum value of the outer diameter φd of the rolling element spacer 5 from a relation with a radius of curvature of the curved portion in the endless circulation passage.

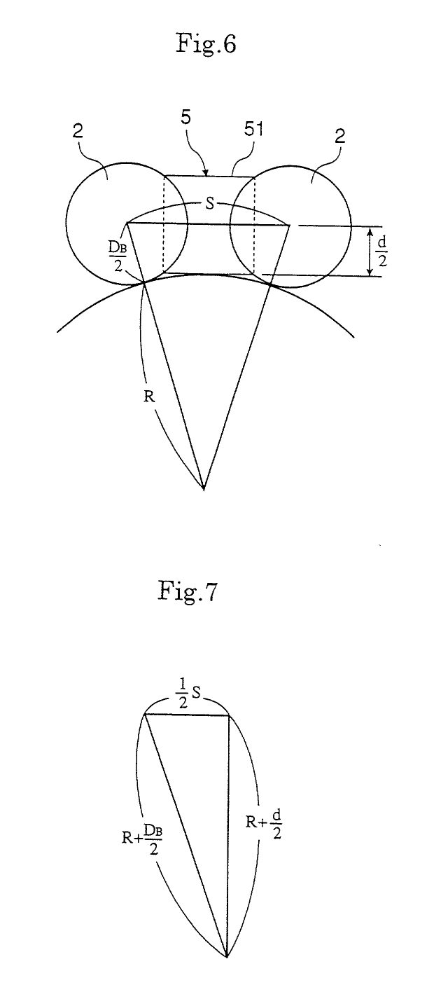

Here, as shown in FIG. 6, if it is supposed that D_{B} is an outer diameter of the ball 2, S an inter-center distance between the mutually adjoining balls 2, 2, R a radius of curvature in an inner diameter side of the endless circulation passage through which the ball 2 circulates and d an outer diameter of the rolling element spacer 5, and if it is imagined that an outer periphery face of the rolling element spacer 5 contacts with an inner wall of the endless circulation passage, it is possible to derive a right-angled triangle having such a dimensional relation as shown in FIG. 7. Accordingly, from the dimensional relation of this triangle, the following equation is established.

(R+D_{B}/2)²=(S/2)²+(R+d/2)²

And, if d is derived from this equation, it becomes as follows.

d (dₘₐₓ)=√{(2R+D_{B})²−S²}−2R (Equation 1)

Incidentally, since the outer periphery face 51 of the rolling element spacer 5 is liable to interfere with the inner wall of the endless circulation passage as the radius of curvature in the curved portion of the endless circulation passage becomes small, R used in the Equation 1 is a minimum radius of curvature in the endless circulation passage.

Since this Equation represents a state that the outer periphery face 51 of the rolling element spacer 5 contacts with the inner wall of the endless circulation passage, i.e., a maximum value dₘₐₓ of the outer diameter of the rolling element spacer 5, in order to prevent the rolling element spacer 5 from interfering with the endless circulation passage, the outer diameter d of the rolling element spacer 5 must be smaller than this dₘₐₓ. That is, if

d<dₘₐₓ=√{(2R+D_{B})²−S²}−2R (Equation 2)

is met, the rolling element spacer 5 can smoothly circulate in the endless circulation passage with the balls 2 without interfering with the inner wall of the endless circulation passage.

Accordingly, on setting the diagonal dimension A of the rolling element spacer 5 larger than the inner diameter φD of the endless circulation passage, it is preferable to set the outer diameter φd of the rolling element spacer 5 as large as possible within a range determined by the Equation 2, and to set the thickness t small. By this, it is possible for the endless circulation passage to arrange the balls 2 in the maximum number while preventing the rolling element spacer 5 from interfering with the endless circulation passage.

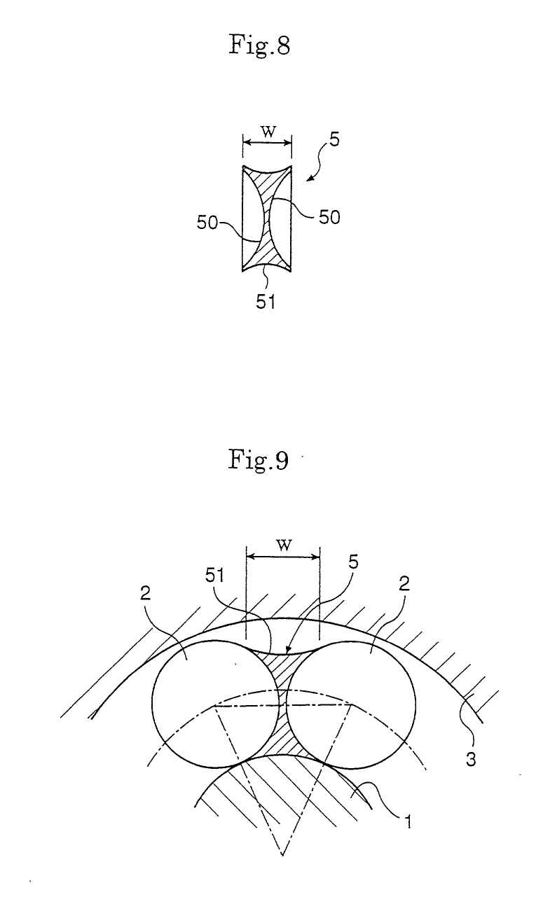

Further, as to the Equation 2, there is imagined a case that the outer periphery face 51 of the rolling element spacer 5 is formed in a cylindrical form. However, as shown in FIG. 8 and FIG. 9, in case that the outer periphery face 51 of the rolling element spacer 5 is formed in a concave face form, since the outer periphery face 51 of the rolling element spacer 5 becomes correspondingly difficult to interfere with the inner wall of the endless circulation passage, it becomes possible to set the outer diameter of the rolling element spacer 5 slightly larger than the aforesaid dₘₐₓ. Accordingly, in this case, it is necessary to add a correction value Δd to the aforesaid dₘₐₓ.

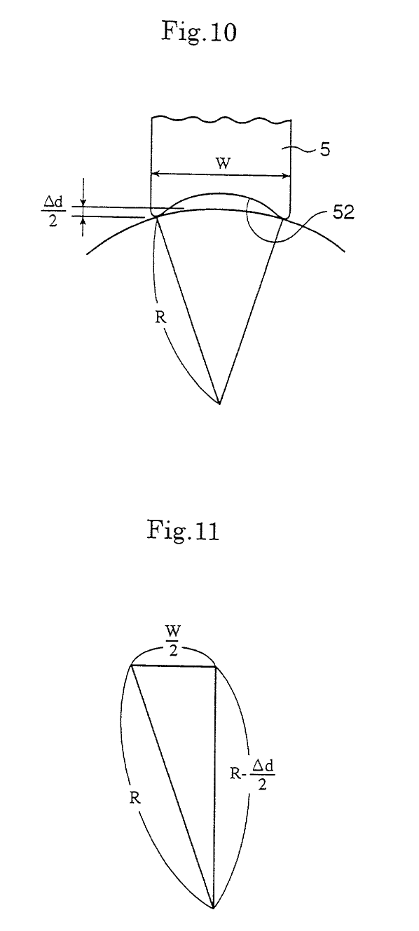

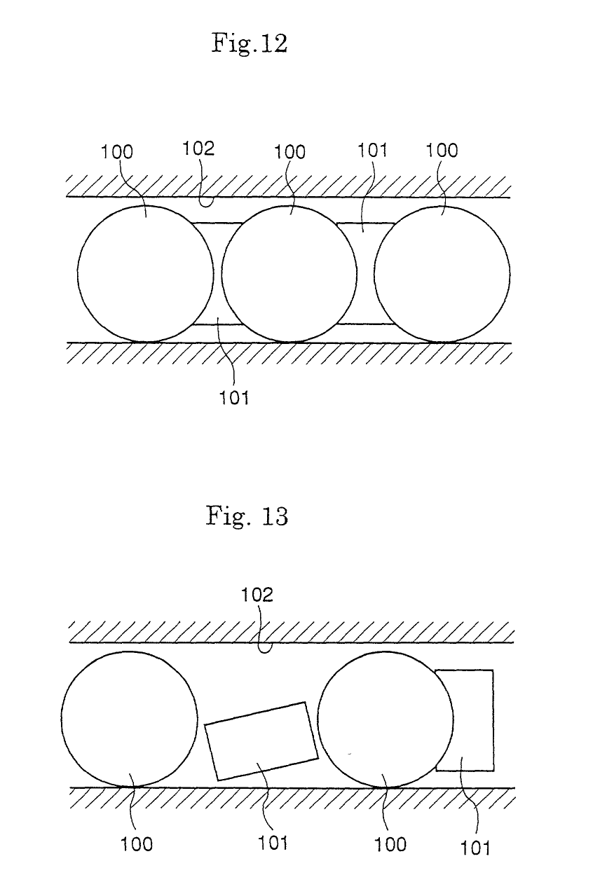

Here, as shown in FIG. 10, if it is supposed that W is a width of a recessed portion 52 formed in the outer periphery face 51 of the rolling element/spacer 5, Δd/2 a height of an inner wall of the endless circulation passage, protruding into the recessed portion 52 and, similarly to the previous time, R the radius of curvature in the inner diameter side of the endless circulation passage, it is possible to derive a right-angled triangle of such a dimensional relation as shown in FIG. 11. Accordingly, from the dimensional relation of this triangle, the following equation is established.

R²(W/2)−√(4R²−W²) (Equation 3)

And, if Δd is derived from this equation, it becomes as follows.

Δd=2R−√(4R²W²) (Equation 4)

And, in case that the recessed portion 52 exists in the outer periphery face 51 of the rolling element spacer 51 in this manner, if the maximum outer diameter φd of the rolling element spacer 5 is smaller than a value obtained by adding the correction value Δd to dₘₐₓ prescribed by the aforesaid Equation 2, i.e., if

φd<dₘₐₓ+2R−√(4R²−W²) (Equation 5)

is met, the outer periphery face 51 of the rolling element spacer 5 is prevented from interfering with the inner wall of the endless circulation passage.

Accordingly, in case that the recessed portion 52 is formed in the outer periphery face 51 of the rolling element spacer 5, it is possible to set the outer diameter of the rolling element spacer 5 larger by the aforesaid Δd than the case where the outer periphery face 51 is formed merely in the cylindrical form. Therefore, on determining the diagonal dimension A, by correspondingly reducing the thickness t of the rolling element spacer 5, the number of the balls 2 in the endless circulation passage can be increased, so that it is possible to increase a rated load of the ball screw device by a more compact constitution and prevent the rolling element spacer 5 from falling sideways in the endless circulation passage.

What is claimed is:

1. A rolling element spacer used in a rolling guide device in which a pair of members perform a relative continuous motion through an endlessly circulating ball row, interposed between balls mutually adjoining in its endless circulation passage, and circulating together with the balls,
characterized in that a diagonal dimension in a thickness direction is larger than an inner diameter of the endless circulation passage.

2. A rolling element spacer set forth in claim 1, characterized in that when it is supposed that DB is a ball diameter, S an inter-center distance of the mutually adjoining balls and R a minimum radius of curvature of the endless circulation passage through which the balls circulate, an outer diameter d meets the following equation
d<√{(2R+D_{B})²−S²}−2R=dₘₐₓ.

3. A rolling element spacer set forth in claim 2, characterized in that an outer periphery face is formed in a concave face form, and when it is supposed that W is a width of its concave face portion, the outer diameter meets the following equation
d<dₘₐₓ+2R√(4R²−W²).
